(19) United States
(12) Patent Application Publication
(10) Pub. No.: US 2013/0008938 A1
(43) Pub. Date: Jan. 10, 2013

(54) METHOD FOR MANUFACTURING PRINTED CIRCUIT BOARD

(75) Inventors: Je Kyoung KIM, Busan (KR); Seong Hoon BAE, Busan (KR); Young Kwan LEE, Busan (KR); Su Jin LEE, Busan (KR)

(73) Assignee: SAMSUNG ELECTRO-MECHANICS CO., LTD., Gyunggi-do (KR)

(21) Appl. No.: 13/234,935

(22) Filed: Sep. 16, 2011

(30) Foreign Application Priority Data
Jul. 8, 2011 (KR) 10-2011-0068004

(51) Int. Cl. B23K 1/20; B23K 31/02

(52) U.S. Cl. 228/203

(57) ABSTRACT

Disclosed herein is a method for manufacturing a printed circuit board, the method including: preparing a base substrate having a connection pad; forming a surface treatment layer on the connection pad; refrigeration-treating the base substrate having the connection pad on which the surface treatment layer is formed; and printing a solder paste on the connection pad of the refrigeration-treated base substrate.

### CROSS REFERENCE TO RELATED APPLICATION

This application claims the benefit of Korean Patent Application No. 10-2011-0068004, filed on Jul. 8, 2011, entitled “Method for Manufacturing Printed Circuit Board”, which is hereby incorporated by reference in its entirety into this application.

### BACKGROUND OF THE INVENTION

1. Technical Field

The present invention relates to a method for manufacturing a printed circuit board.

2. Description of the Related Art

A printed circuit board generally includes a connection pad exposed to the outside so that components such as a semiconductor, or the like, may be mounted thereon.

The connection pad is generally made of a copper (Cu) material. However, since copper exposed to the outside may be oxidized and corroded with the passage of time, a surface treatment layer is formed on the exposed connection pad in order to prevent a damage of the exposed connection pad.

Various methods for forming a surface treatment layer have been currently used. Among them, there is an immersion tin (IT) plating method, which is an electroless plating method. The immersion tin plating method, which is an electroless tin plating method using an oxidation/reduction potential between tin (Sn) and copper (Cu), has also been widely used in a flexible circuit board (FCB) field.

The above-mentioned electroless tin plating method is excellent in view of a cost as compared to a gold plating method. However, in the case of the electroless tin plating method, a solder bump is separated from the connection pad during a process of forming the solder bump, which is a post-process.

That is, in the case in which the tin (Sn) is plated on the connection pad made of the copper (Cu) through the electroless tin plating, intermetallic compounds (hereinafter, referred to as ‘IMCs’) called Cu₃Sn are produced in a copper/tin interface due to a difference in solid solubility of the tin (Sn) within the copper (Cu) immediately after the plating. The IMCs produced as described above are grown together with Cu₆Sn₅ during the progress of a process, such that there are IMSs Cu₃Sn and Cu₆Sn₅ having an average thickness of about 0.68 μm in the copper (Cu)/tin (Sn) interface as shown in FIG. 1.

As described above, as the IMCs are grown, a thickness of pure tin (Sn) becomes relatively thinner than that of pure tin (Sn) immediately after the plating as shown in FIG. 1, such that wettability between a solder paste and the tin (Sn) interface is deteriorated. Therefore, spreadability of a flux is deteriorated and interdiffusion between the copper (cu) and the solder paste is hindered, such that the solder bump is separated from the connection pad due to an insufficient reaction between the connection pad and the solder paste after a reflow process is performed.

### SUMMARY OF THE INVENTION

The present invention has been made in an effort to provide a method for manufacturing a printed circuit board capable of suppressing growth of intermetallic compounds in an interface between a connection pad made of copper (Cu) and a surface treatment layer made of tin (Sn).

Further, the present invention has been made in an effort to provide a method for manufacturing a printed circuit board capable of preventing separation of a solder bump formed on a connection pad.

According to a preferred embodiment of the present invention, there is provided a method for manufacturing a printed circuit board, the method including: preparing a base substrate having a connection pad; forming a surface treatment layer on the connection pad; refrigeration-treating the base substrate having the connection pad on which the surface treatment layer is formed; and printing a solder paste on the connection pad of the refrigeration-treated base substrate.

The connection pad may be made of copper (Cu).

The forming of the surface treatment layer may be performed by an electroless tin plating process.

The refrigeration-treating of the base substrate may be performed for 1 to 2 hours and be performed at a temperature of 0° C. to 5° C.

The solder paste may be at least one of a Sn—Pb based solder paste, a Sn—Ag solder paste, a Sn—Cu solder paste, and a Sn—Ag—Cu solder paste.

The method may further include, after the printing of the solder paste, forming a solder bump by performing a reflow process on the solder paste; and removing a flux remaining on a surface of the solder bump.

The preparing of the base substrate may include: preparing a substrate on which an outermost layer of circuit including the connection pad is formed; forming a solder resist layer on the substrate; and forming an opening part exposing the connection pad in the solder resist layer.

### BRIEF DESCRIPTION OF THE DRAWINGS

FIG. 1 is a view showing a state in which intermetallic compounds (IMCs) are grown in an interface between a connection pad (Cu) and a surface treatment layer (Sn) of a printed circuit board formed according to the prior art;

FIG. 2 is a flow chart showing a method for manufacturing a printed circuit board according to a preferred embodiment of the present invention;

FIG. 3 is a view showing a state of an interface between a connection pad (Cu) and a surface treatment layer (Sn) of a printed circuit board formed by a method for manufacturing a printed circuit board according to a preferred embodiment of the present invention;

FIG. 4 is a graph showing growth thicknesses of IMCs for each process condition (temperature); and

FIG. 5 is a graph showing a degree of scattering of thicknesses of IMCs for each process condition (temperature).

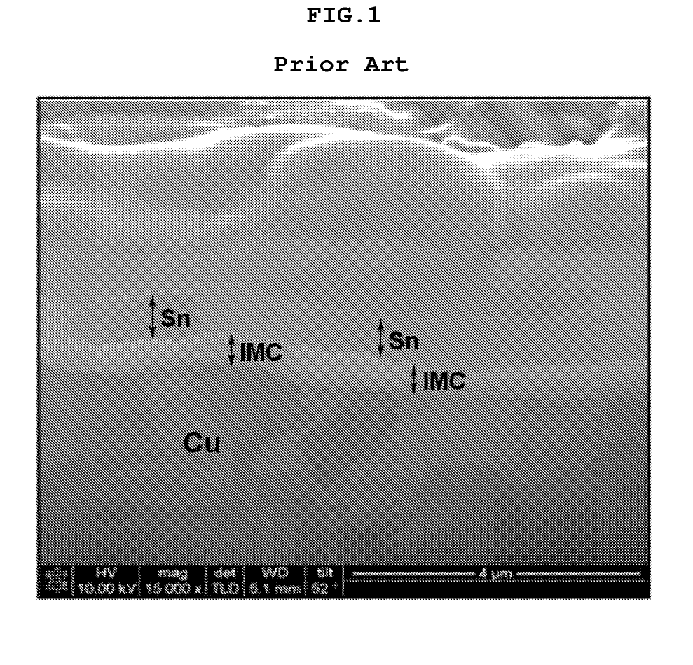

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from preferred embodiments and the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second”, and so on are used to distinguish one element from another element, and the elements are not defined by the above terms.

Hereinafter, preferred embodiments of the present invention will be described in detail with reference to the accompanying drawings.

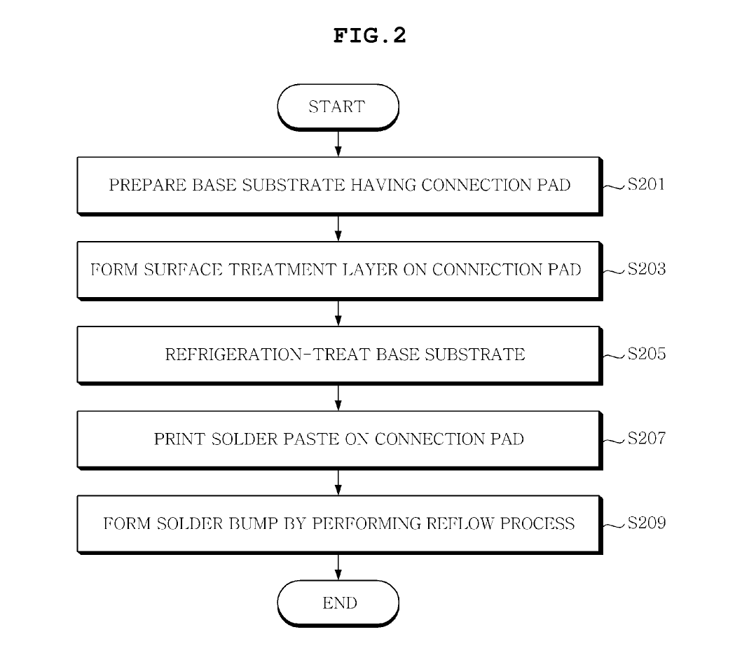

FIG. 2 is a flow chart showing a method for manufacturing a printed circuit board according to a preferred embodiment of the present invention.

A base substrate having a connection pad is first prepared (S201).

According to the present embodiment, the preparing of the base substrate may include preparing a substrate on which an outermost layer of circuit including the connection pad is formed, forming a solder resist layer on the substrate, and forming an opening part exposing the connection pad in the solder resist layer.

Here, the opening part may be formed by a photolithography method or a laser method including exposure and development.

The base substrate, which is a circuit substrate on which at least one layer of circuit including the connection pad is formed on an insulating layer thereof, may be a printed circuit board.

As the insulating layer, a resin insulating layer may be used. As materials of the resin insulating layer, a thermo-setting resin such as an epoxy resin, a thermo-plastic resin such as a polyimide resin, a resin having a reinforcement material such as a glass fiber or an inorganic filler impregnated in them, for example, a prepreg may be used. In addition, a thermo-setting resin, a photo-setting resin, and the like, may be used. However, the materials of the resin insulating layer are not specifically limited thereto.

In addition, the circuit including the connection pads may be made of any material used as a conductive metal for a circuit in a circuit substrate field, and is typically made of copper in the case of a printed circuit board.

The solder resist layer serves as a protective layer protecting the outermost layer of circuit of the printed circuit board, is formed for electrical insulation, and includes the opening part formed in order to expose the outermost layer of connection pad. A solder resist configuring the solder resist layer may be, for example, solder resist ink, a solder resist film, an encapsulant, or the like, as known in the art, but is not specifically limited thereto.

Then, a surface treatment layer is formed on the connection pad (S203).

A process for forming the surface treatment layer may be generally divided into an electro gold plating process, an immersion gold plating process, an organic solderability preservative (OSP) or immersion tin plating process, an immersion silver plating process, an electroless nickel and immersion gold (ENIG) process, a direct immersion gold (DIG) plating process, a hot air solder leveling (HASL) process, or the like. According to the present embodiment, the surface treatment layer is formed by using the immersion tin plating process.

Next, the base substrate having the surface treatment layer, for example, a tin plating layer, formed on the connection pad thereof is refrigeration-treated (S205).

Here, the refrigeration-treating may be performed by storing the base substrate in an apparatus in which the base substrate may be stored in a low temperature state for a predetermined time.

According to the present embodiment, the base substrate is refrigeration-treated at a temperature of 0 to 5° C. for about 1 to 2 hours.

During a real process for manufacturing a printed circuit board, a work-in-process congestion phenomenon in which a process for forming a solder bump may not be performed immediately after the surface treatment layer is formed on the connection pad of the base substrate is frequently generated.

As time passes in a state in which the solder bump is not formed after the formation of the surface treatment layer due to the work-in-process congestion, Cu₃Sn, which is an intermetallic compound (IMC) between copper (Cu) and tin (Sn) produced in an interface between the connection pad and the surface treatment layer is grown Cu₆Sn₅. However, when the base substrate having the surface treatment layer formed thereon is refrigeration-treated under the above-mentioned temperature and time condition, growth of the IMCs in the interface between the connection pad and the surface treatment layer may be suppressed until a process for forming a solder bump, which is a subsequent process, is performed.

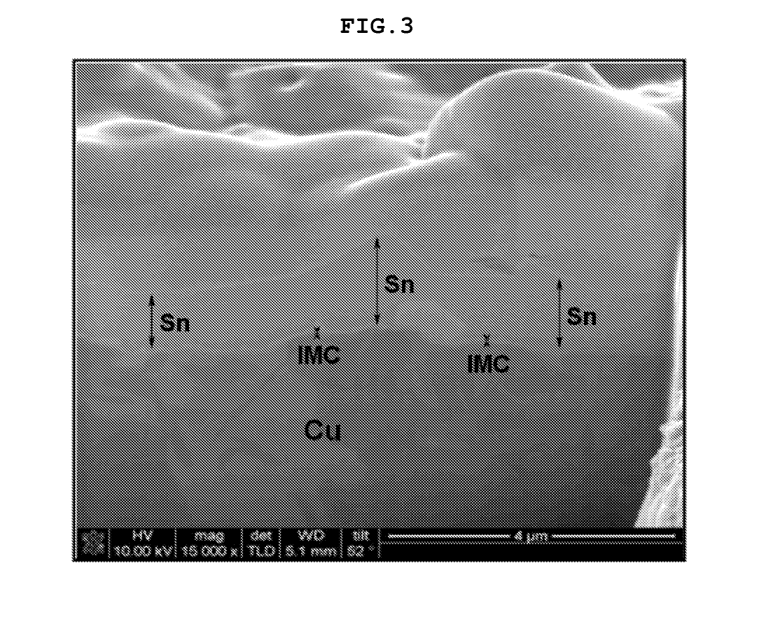

A state of the base substrate after the refrigeration-treating process is performed on the base substrate under the above-mentioned condition, for example, at a temperature of 0 to 5° C. for about 1 to 2 hours and a predetermined period (a week in the present embodiment) then passes is shown in FIG. 3. Referring to FIG. 3, it may be appreciated that the IMCs have scarecely been grown in the interface between the connection pad made of Cu and the surface treatment layer, which is the tin (Sn) plating layer.

Thereafter, a solder paste is printed on the connection pad of the refrigeration-treated base substrate (S207).

Here, as a method for printing the solder paste, a method of disposing a mask including an aperture part formed at a position corresponding to the connection pad on the base substrate and filling the solder paste in the aperture part using a squeegee may be generally used. However, the method for printing the solder paste is not specifically limited thereto.

Here, the solder paste may be configured of 50 wt % of solder particle components and 50 wt % of flux components combining the solder particle components to each other but is not specifically limited thereto.

In addition, the solder paste may be at least one of a Sn—Pb based solder paste, a Sn—Ag solder paste, a Sn—Cu solder paste, and a Sn—Ag—Cu solder paste but is not specifically limited thereto.

Then, a solder bump is formed by performing a reflow process on the solder resist (S209).

The reflow process, which is a process for melting the solder paste to thereby attach the solder past to the connection pad, is performed after the mask that has been disposed on the base substrate in order to print the solder paste is removed. The reflow process may be generally performed at a maximum temperature of 200 to 300° C. but is not specifically limited thereto. For example, a reflow temperature may be changed according to components contained in the solder paste.

Most of the flux components mixed with the solder paste are volatilized at the time of the reflow. However, since some of the flux components may remain in the solder bump without being volatilized, a deflux process of cleaning and removing the flux components remaining in the solder bump and the connection pad may be additionally performed.

The following Table 1 shows experimental data obtained by comparing solder bump separation ratios of each of the base substrates each having the surface treatment layer formed on the connection pad made of the copper (Cu) through the electroless tin plating process and being subjected to refrigeration-treatment at temperatures of 0° C., 3° C., and 5° C. for 1 hour with a solder bump separation ratio of a base substrate being not subjected to the refrigeration-treatment.

After a predetermined period (a week in the present embodiment) passes, each of the solder bumps was formed on each of the connection pads of the base substrates each being subjected to the refrigeration-treatment and being not subjected to the refrigeration-treatment.

TABLE 1

| | | | Solder Bump |
|---|---|---|---|
| | Refrigeration Treatment | Process Condition | Separation |
| No. | Time | (Temperature) | Ratio (%) |
| 1 | Refrigeration-Treatment is | 25° C.~30° C. | 11.4% |
| | not performed | | |
| 2 | 1 hour | 0° C. | 1.9% |
| 3 | 1 hour | 3° C. | 2.2% |
| 4 | 1 hour | 5° C. | 2.1% |

As shown in Table 1, it may be appreciated that the separation ratio in which the solder bump formed on the connection pad of the base substrate being subjected to the refrigeration-treatment at a temperature of 0 to 5° C. for about 1 hour is separated from the connection pad is significantly lower than that of the solder bump formed on the connection pad of the base substrate being not subjected to the refrigeration-treatment

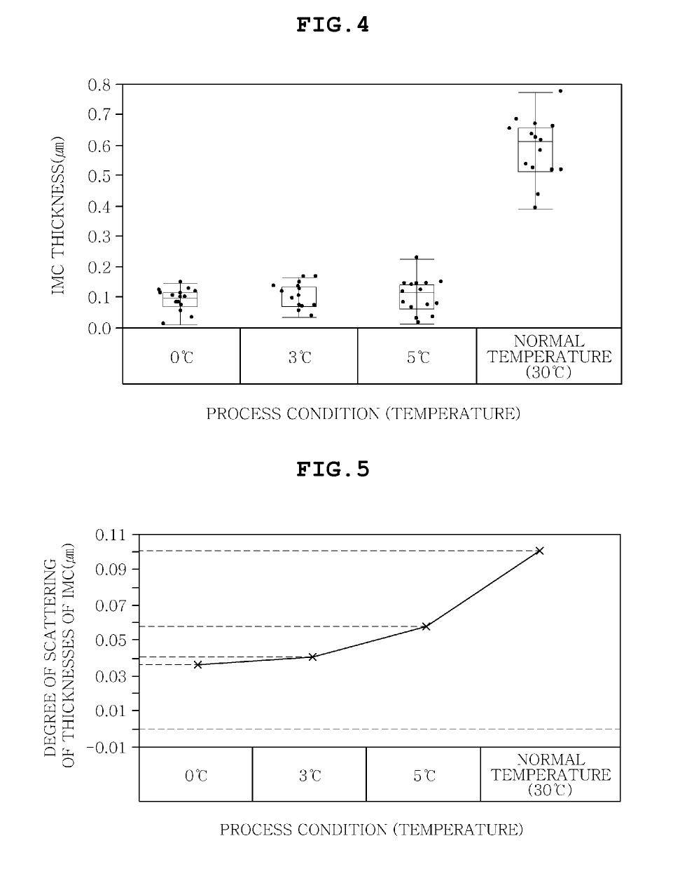

In addition, the correlation between thicknesses of IMCs formed in the interface between the connection pad and the surface treatment layer of each of the base substrates being subjected to the refrigeration-treatment at temperatures of 0° C., 3° C., and 5° C. for 1 hour and the base substrate being not subjected to the refrigeration-treatment, and whether or not the refrigeration-treatment is performed and the refrigeration-treatment temperature is shown in a graph of FIG. 4.

In FIG. 4, an X axis indicates cases in which the refrigeration-treatment is performed at temperatures of 0° C., 3° C., and 5° C., respectively, and a case in which the refrigeration-treatment is not performed, and a Y axis indicates a thickness of the IMC produced in the interface between the connection pad (Cu) and the surface treatment layer (Sn).

Referring to FIG. 4, measurement values of thicknesses of IMCs produced in interfaces between connection pads and surface treatment layers of a plurality of base substrates being subjected to refrigeration-treatment at a temperature of 0° C. are represented by a plurality of points. Likewise, measurement values of thicknesses of IMCs produced in a plurality of base substrates being subjected to refrigeration-treatment at temperatures of 3° C. and 5° C. and IMCs produced in a plurality of base substrates being not subjected to the refrigeration-treatment are represented by a plurality of points.

Here, a central tetragonal box indicates a range in which the measurement values are distributed, and marks ‘-’ over and under the central tetragonal box indicate the maximum and minimum values of the measured thicknesses.

A standard deviation of remaining values except for the maximum and minimum values of the measured thicknesses was calculated, and a degree of scattering of thicknesses of IMCs produced for each process condition (temperature) was shown in a graph of FIG. 5.

Referring to FIG. 5, a degree of scattering of thicknesses of the IMCs produced in the plurality of base substrates being subjected to the refrigeration-treatment at a temperature of 0° C. was approximately 0.036, a degree of scattering of thicknesses of the IMCs produced in the plurality of base substrates being subjected to the refrigeration-treatment at a temperature of 3° C. was approximately 0.041, a degree of scattering of thicknesses of the IMCs produced in the plurality of base substrates being subjected to the refrigeration-treatment at a temperature of 5° C. was approximately 0.058, and a degree of scattering of thicknesses of the IMCs produced in the plurality of base substrates being not subjected to the refrigeration-treatment was approximately 0.101.

Here, it may be appreciated that the thickness of the IMC produced in the base substrate being subjected to the refrigeration-treatment is relatively more uniform than that of the IMC produced in the base substrate being not subjected to the refrigeration-treatment.

As such, the surface treatment layer is formed on the connection pad of the base substrate and the base substrate is then refrigeration-treated at a predetermined temperature for a predetermined time, thereby making it possible to suppress the growth of the IMC in the interface between the connection pad and the surface treatment layer.

As described above, the growth of the IMC is suppressed to prevent the thickness of pure tin (Sn), which is the surface treatment layer, from being thinned, such that the spreadabilities of the solder paste and the flux on the surface treatment layer are improved and the interdiffusion between the connection pad (Cu) and the solder paste is smoothly performed, thereby making it possible to prevent the solder bump from being separated from the connection pad after the reflow.

As set forth above, according to the preferred embodiment of the present invention, the surface treatment layer is formed on the connection pad made of the copper (Cu) through the electroless tin plating process and is then subjected to the refrigeration-treatment for a predetermined time, thereby making it possible to suppress the growth of the IMC in the interface between the connection pad and the surface treatment layer.

In addition, according to the preferred embodiment of the present invention, the growth of the IMC in the interface between the connection pad and the surface treatment layer is suppressed, thereby making it possible to prevent the solder bump formed on the connection pad from being separated from the connection pad.

Further, according to the preferred embodiment of the present invention, the separation of the solder bump from the connection pad is prevented as described above, thereby making it possible to reduce a product defect and a manufacturing cost.

Although the preferred embodiments of the present invention have been disclosed for illustrative purposes, they are for specifically explaining the present invention and thus a method for manufacturing a printed circuit board according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A method for manufacturing a printed circuit board, the method comprising:
preparing a base substrate having a connection pad;
forming a surface treatment layer on the connection pad;
refrigeration-treating the base substrate having the connection pad on which the surface treatment layer is formed; and
printing a solder paste on the connection pad of the refrigeration-treated base substrate.

2. The method as set forth in claim 1, wherein the connection pad is made of copper (Cu).

3. The method as set forth in claim 1, wherein the forming of the surface treatment layer is performed by an electroless tin plating process.

4. The method as set forth in claim 1, wherein the refrigeration-treating of the base substrate is performed for 1 to 2 hours.

5. The method as set forth in claim 1, wherein the refrigeration-treating of the base substrate is performed at a temperature of 0° C. to 5° C.

6. The method as set forth in claim 1, wherein the solder paste is at least one of a Sn—Pb based solder paste, a Sn—Ag solder paste, a Sn—Cu solder paste, and a Sn—Ag—Cu solder paste.

7. The method as set forth in claim 1, further comprising, after the printing of the solder paste, forming a solder bump by performing a reflow process on the solder paste; and removing a flux remaining on a surface of the solder bump.

8. The method as set forth in claim 1, wherein the preparing of the base substrate includes:
preparing a substrate on which an outermost layer of circuit including the connection pad is formed;
forming a solder resist layer on the substrate; and
forming an opening for exposing the connection pad in the solder resist layer.
